(19) United States
(12) Patent Application Publication
(10) Pub. No.: US 2025/0320772 A1
(43) Pub. Date: Oct. 16, 2025

(54) TOP DRAINAGE SYSTEM FOR WINDOWS AND/OR DOORS

(71) Applicant: HAWKES DESIGN AND CONSULTING, LLC, Charleston, SC (US)

(72) Inventor: Henry M. Hay, III, Charleston, SC (US)

(73) Assignee: HAWKES DESIGN AND CONSULTING, LLC, Charleston, SC (US)

(21) Appl. No.: 19/176,976

(22) Filed: Apr. 11, 2025

Related U.S. Application Data
(60) Provisional application No. 63/633,296, filed on Apr. 12, 2024.

(51) Int. Cl. E06B 7/14

(52) U.S. Cl. CPC E06B 7/14

(57) ABSTRACT

Various embodiments of the present disclosure include drainage systems for window and/or door frames and methods of manufacturing the same. An example drainage system includes a frame with a head. The example drainage system also includes a water channel adjacent to the head defined between a water channel opening and a water channel outlet. Water travels along the water channel. The example drainage system further includes a first wicking structure positioned within the water channel. The first wicking structure includes an absorption layer and the water traveling along the water channel exits on an exterior side of the frame.

### CROSS-REFERENCE TO RELATED APPLICATION

The present application claims the benefit of U.S. Provisional Patent Application No. 63/633,296 filed Apr. 12, 2024, and titled “TOP DRAINAGE SYSTEM FOR WINDOWS AND/OR DOORS.” The contents of the application are incorporated by reference in its entirety.

### TECHNICAL FIELD

The present disclosure relates generally to windows, doors and the like, and, more specifically to the draining of water ingress, such as rainwater, from a window or door frame.

### BACKGROUND

To make a penetration in a building, for example, for a window, a rough opening is made in the wall for a window frame to be secured to the wall surrounding that opening. The installation of the window should be done so as to allow rain that falls on the building and on the window to be shed and the water be prevented from entering the interior of the building, especially from entering the inside of the walls of the building. Water that penetrates is ideally returned to the exterior of the building through “weep holes.” However, traditional weep holes are easily blocked by debris and difficult to clean. Therefore, there exists a need for a way to remove water so as to not easily clog and/or block a weep hole, as well as to create a uniform profile and appearance to hide unsightly openings.

### SUMMARY

According to its major aspects and briefly recited, the present system is a window and/or door frame that includes wicking structure(s) along the head of the frame. The wicking structure(s) may operate as a top drainage system for the frame.

In some aspects, the techniques described herein relate to a drainage system for a window or a door, the system including: a frame including a head; a water channel adjacent to the head defined between a water channel opening and a water channel outlet, wherein water travels along the water channel; and a first wicking structure positioned within the water channel, wherein the first wicking structure includes an absorption layer, wherein the water traveling along the water channel exits on an exterior side of the frame.

In some aspects, the techniques described herein relate to a system, further including a water channel cover, wherein the water channel is defined between the water channel cover and the head.

In some aspects, the techniques described herein relate to a system, wherein the water channel is defined between the head and a pane of the frame.

In some aspects, the techniques described herein relate to a system, wherein a portion of the water channel includes a water channel aperture defined within the frame.

In some aspects, the techniques described herein relate to a system, further including a directing structure positioned adjacent to an interior side of the frame, wherein water is prevented from exiting the interior side of the frame via the directing structure.

In some aspects, the techniques described herein relate to a system, wherein the water channel is slanted along the water channel in a direction of the water channel outlet.

In some aspects, the techniques described herein relate to a system, wherein the first wicking structure defines an inlet aperture and an outlet aperture, wherein the inlet aperture and the outlet aperture are defined between a clipping cover of the first wicking structure and the head of the frame.

In some aspects, the techniques described herein relate to a system, wherein the outlet aperture of the first wicking structure is the water channel outlet.

In some aspects, the techniques described herein relate to a system, wherein the absorption layer includes a foam tape.

In some aspects, the techniques described herein relate to a system, wherein the absorption layer is an open-cell foam.

In some aspects, the techniques described herein relate to a system, further including a water channel cover that directs the water exiting the water channel outlet.

In some aspects, the techniques described herein relate to a system, further including at least one additional wicking structure, wherein each of the first wicking structure and the at least one additional wicking structure is defined along the head.

In some aspects, the techniques described herein relate to a system, wherein the frame is for a window.

In some aspects, the techniques described herein relate to a system, wherein the frame is for a door.

In some aspects, the techniques described herein relate to a system, wherein the water channel directs the water from an interior side to the exterior side of the frame.

In some aspects, the techniques described herein relate to a method of manufacturing a drainage system for a window or a door, the method including: providing a frame including a head; defining a water channel adjacent to the head between a water channel opening and a water channel outlet, wherein water travels along the water channel; and positioning a first wicking structure on the head within the water channel, wherein the first wicking structure includes an absorption layer, wherein the water traveling along the water channel exits on an exterior side of the frame.

In some aspects, the techniques described herein relate to a method, further including attaching a water channel cover to the head, wherein the water channel is defined between the water channel cover and the head.

In some aspects, the techniques described herein relate to a method, wherein the water channel is defined between the head and a pane of the frame.

In some aspects, the techniques described herein relate to a method, wherein a portion of the water channel includes a water channel aperture defined within the frame.

In some aspects, the techniques described herein relate to a method, further including defining a directing structure adjacent to an interior side of the frame, wherein water is prevented from exiting the interior side of the frame via the directing structure.

In some aspects, the techniques described herein relate to a method, wherein the water channel is slanted along the water channel in a direction of the water channel outlet.

In some aspects, the techniques described herein relate to a method, wherein the first wicking structure defines an inlet aperture and an outlet aperture, wherein the inlet aperture and the outlet aperture are defined between a clipping cover of the first wicking structure and the head of the frame.

In some aspects, the techniques described herein relate to a method, wherein the outlet aperture of the first wicking structure is the water channel outlet.

In some aspects, the techniques described herein relate to a method, wherein the absorption layer includes a foam tape.

In some aspects, the techniques described herein relate to a method, wherein the absorption layer is an open-cell foam.

In some aspects, the techniques described herein relate to a method, further including providing a water channel cover that directs the water exiting the water channel outlet.

In some aspects, the techniques described herein relate to a method, further including positioning at least one additional wicking structure, wherein each of the first wicking structure and the at least one additional wicking structure is defined along the head.

In some aspects, the techniques described herein relate to a method, wherein the frame is for a window.

In some aspects, the techniques described herein relate to a method, wherein the frame is for a door.

In some aspects, the techniques described herein relate to a method, wherein the water channel directs the water from an interior side to the exterior side of the frame.

These and other features of the present apparatus and method will be readily apparent to those skilled in the art of window manufacture and design from a careful reading of the Detailed Description that follows.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is front view of a manufactured window frame with window including a wicking structure in accordance with various embodiments of the present disclosure;

FIG. 2 is a perspective view of a window frame with a wicking structure positioned on the head, in accordance with various embodiments of the present disclosure;

FIG. 3 is a cross-sectional view of a foam material used as an absorption layer, in accordance with various embodiments of the present disclosure;

FIG. 4 is front view of a manufactured window frame with window including wicking structures, in accordance with various embodiments of the present disclosure;

FIG. 5 is a cross-sectional view showing a water channel used to remove water from within the window frame, in accordance with various embodiments of the present disclosure;

FIG, 6 is cross-section view showing another example water channel used to remove water from within the window frame, in accordance with various embodiment of the present disclosure; and

FIG. 7 is another example wicking structure used on a door frame, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

The term “water” may be used interchangeably with liquid to describe any liquid substance that moves through the window drainage system or that may be introduced to an exterior of a building. As such, the term water may include any mixture of liquids that may pass through the window drainage system (e.g., clean water, rainwater, salt water, contaminated liquids, and/or the like). As such, the term water is not limiting to only pure H₂0.

While the present disclosure discusses a drainage system for window frames, the drainage system may also be used for other frames, such as door frames. As such, the term window frames are not meant to be limited to exclusively window frames unless otherwise noted.

To make a penetration in a building, for example, for a window, a rough opening is made in the wall for a window frame to be secured to the wall surrounding that opening. The installation of the window should be done so as to allow rain that falls on the building and on the window to be shed and be prevented from entering the interior of the building, and especially from entering the inside of the walls of the building or becoming standing water. Water that penetrates is ideally returned to the exterior of the building through “weep holes.”

In addition to building penetrations for windows, penetrations are also made for a packaged terminal air conditioner, a hose bib, electrical junction boxes, dryer vents, flush lighting fixtures, and exhaust vents. Each penetration may require a frame that needs to be sealed against water intrusion in a similar manner.

Weep holes in general are pathways provided in a structure to enable water that enters an opening in the structure to drain to the outside of the structure. Windows fabricated of extruded polyvinyl chloride components may be made with weep holes. As long as the weepholes are periodically serviced, they perform well. Nonetheless, the window frame may still admit some water, for example, the area outside the window frame, between the window frame and the wall, can become a source of water intrusion that should be routed back to the exterior. Further, the top side of the window may allow for water entering if the flashing fails or is improperly installed, or if the clapboard or other material has a gap that allows water to penetrate to the interior of the wall.

A window frame is fitted to a hole made for it, sometimes called a “rough opening”, in the wall of the building. The edges of the rough opening are covered with water-repellant cover flashing tape to seal the walls and window surfaces at the rough opening from water intrusion.

The extruded vinyl window frame to be installed in the rough opening may include a lateral flange or “nail fin” on its perimeter that extends from the window frame over the sides of the hole in the wall to cover the marginal edge of the hole for the window and to serve as a broad surface for engaging the wall and for facilitating the fastening and sealing the window to the building.

The nail fin is fastened to the wall and water-proof flashing tape is applied over it. Before it is fastened, however, a water-proof sealant or mastic may be applied in the form of a bead under the nail fin, on the surface that will engage the exterior wall of the house around the rough opening. Other structures may be added to the exterior, such as flashing and drip guards to help prevent the intrusion of water into the window or into the wall that holds the window structure to the exterior.

One type of weep hole common in the installation of windows is made by leaving gaps in the sealant bead as it is being applied to the bottom of the nail fin. The sealant limits lateral movement of water from behind the window. At the gaps in the sealant, the otherwise confined water can fall to the bottom of the fin and drain to the outside of the building. This rainwater moves by gravity and surface tension down to the bottom of the nail fin following the sealant bead toward the “weep holes” (gaps in the sealant) and then to the exterior of the building, and in response to gravity.

These weep holes trap insects and debris, which, in time, limit or block the escape of the water from the window. Furthermore, the gaps in the sealant bead may not be uniform and some may be too narrow, especially if the sealant has spread because of the pressure applied to the nail fin on installation. Accordingly, gaps left in the sealant are not always effective “weep holes” for shedding water and may in time become clogged by insects and dirt. These weep holes may in fact admit water when subjected to required post-installation, industry-approved water penetration tests. During such a test, the weep hole or pathway for water removal may act as an entry point for water.

Moreover, leaks that occur above the window or door may pass around the framing and further trap within the interior portions of a wall. Thus, there remains a need for a better way to make a window head that reliably prevents insect infestation and sheds rainwater, or other water entry from above the window, particularly in geographic areas that are prone to rainy weather, and weather phenomenon such as hurricanes.

There is no current system to weep or otherwise remove water that enters the glazing system of a window behind the vapor barrier. Water that pools on the head of a window or door seeps into the window jamb and settles on the sill of the window. The water causes damage to the frame and/or the area around the window frame, such as the frame of the wall in which a window is inserted.

Various embodiments of the present disclosure allow for water to be removed from the window frame and reduces and/or eliminates pooling of water along the window frame. To do this, water that enters behind the vapor barrier of a window is directed an absorption layer that removes the water to the exterior side of the window. To do this, the absorption layer (e.g., a foam tape and/or the like) is provided along the top edge of the window and runs along the top edge before crossing towards the exterior side of the window, causing the water to be directed out of the window frame (e.g., to the outside). The water direction may be assisted via a tilted surface (e.g., a downward tilt in the direction in which the water is to be directed, which may be the direction of the exterior of the window) and/or a weep barrier which acts as a dam to prevent the water from entering the interior side of the window.

### I. Example Use Case

Various embodiments of the present disclosure may be used for a window and/or door frame. Namely, the present disclosure teaches providing a wicking structure on a window head to collect water and/or other liquids that may fall toward or around and within the window frame. A channel (within which the wicking structure is positioned) located below the nailing exterior face may collect water from outside the window as a result of rain, melted snow, window washing, and condensation. Collected water may drip downward and across the channel at the head of the window. The weep holes, or water evacuation structure may be configured at the top of the window head, and below the exterior drip cap, thus allowing the window head to receive water that may be in the interior of the wall cladding, and to evacuate it prior to accumulating further, thus saving costly damage and repair to the internal wall sheathing and framing, and eliminating what would otherwise be trapped water.

A bead of sealant is applied to keep the draining water away from the edge of nail fin and nailing exterior face. At the top of the window frame, a lineal below the nailing exterior face carries at least one wicking structure that includes a foam patch, that are bounded on the left and right by an extrusion wall or tab that helps to dam the flow of water at the head of the window for evacuation. Water that drains, on reaching foam patches, is wicked into the foam and then drains naturally by a combination of gravity, wicking, surface tension and pressure from the water coming behind it.

The foam patch (also referred to as an absorption layer) of each wicking structure (e.g., two spaced-apart foam patches), is positioned immediately adjacent to the ends of the sealant bead that is applied around the sides and top of the nail fin so as to limit the intrusion of the water and confine the water so the water must run to the bottom of the window frame, constrained along its way by the sealant bead on the fin and water-proof cover, until the water reaches the open-cell foam of the wicking structure(s) at the bottom of the nail fin. The water is directed to the exterior of the building.

The wicking structure with a protective cover readily wicks moisture from inside the perimeter defined by the sealant bead and carries the liquid to the exterior of the building. The open-cell foam of the absorption layer will block the path of insects, such as bees, wasps, gnats, and flies, that may otherwise attempt to enter the window frame and the building. The protective cover and foam block the sealant from entering the foam.

The use of open-cell foam is an aspect of the disclosure. Open-cell foam wicks water into the weep hole while also serving as a physical barrier against the intrusion of insects. The open-cell foam may be made of a plastic that is inexpensive and capable of remaining as an effective barrier to insects over long periods of time. Further, open-cell foam allows the entry to obtain fresh air, and thus alleviates the buildup of mold, algae, and other debris.

Another aspect of the present device is that the foam patches of the wicking structure can be provided as part the window frame by the manufacturer in contrast to the prior art method of entrusting the installer with the task of leaving gaps of the right size and right locations in the sealant bead for the weep holes. The present weep holes, in sharp contrast with the prior art, can be designed and manufactured to specification, and then properly positioned, oriented and securely adhered to a window frame, and thus provide a uniform (as to position, dimensions, and materials) weephole, just as the balance of the window itself is precision engineered and manufactured according to its engineered design, rather than being left for the ad hoc approach of the jobsite. The foam patches in place on the window frames that arrive at the jobsite also establish where the sealant bead starts and stops, defining the end points of the sealant bead which are determined by the engineered and pre-established locations for weep holes.

In the present sense, to be engineered means to be built and positioned as a result of analysis, design, and modern precision manufacturing. The wicking structure(s), by their location on the nail fin of the delivered window frame, direct the installer as to exactly where the bead of sealant is to go, and by implication, where it should not go, so that when the window is pushed into position, the thick sealant will not be spread into the weep hole but be resisted by the sides of the patches. Engineered manufacturing avoids and limits sealant spread into a weephole and helps to assure a precision seal and the reliable operation of the weep holes for the windows, and reduces installation time and errors. Moreover, the foam patches may be sized for the local climate, such as being made with a larger cross-section for tropical or semi-tropical locations.

Additionally, the open-cell foam of the wicking structures prevents many insects, such as bees, wasps, hornets and flies from entering the interior of window and the window frame of the house.

Also of importance is that the design, materials, placement, and application of the foam patches are engineered as part of the engineered window frame. Instead of depending on installers to leave gaps in the sealant bead at the right places, foam patches are designed in size, shape, materials, numbers, and locations and then applied below the drop cap and exterior face nailing surface during manufacture. Furthermore, foam patches can be customized just as the thermal efficiency, soundproofing, ultraviolet and infrared resistance, and scratch-resistance of window pane may be customized for the environment of the locale of expected use.

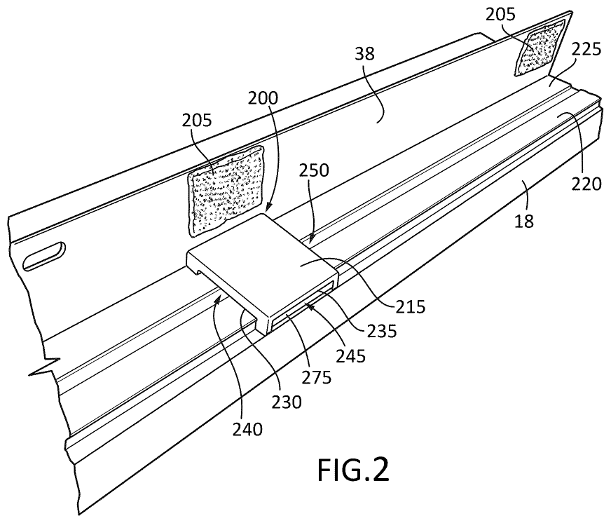

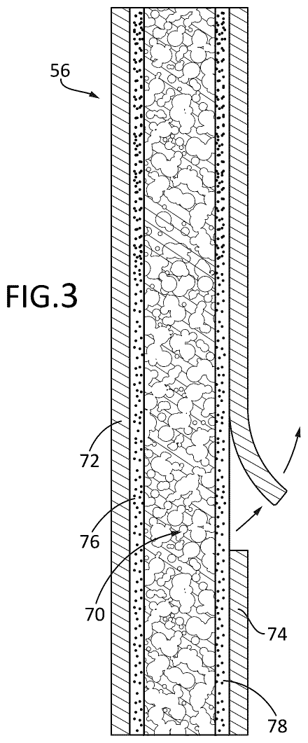

In installation, and as shown in FIGS. 2 and 3, window is installed by applying a foam patch on the head of window. Sealant may further be used to seal the top nailing surface to the wall or structure.

In manufacture, the components of window frame are manufactured by extrusion or milling and then assembled and fastened. Foam patches are placed on the head of the window frame, and may be located at a central position to channel water down the exterior of the window. The placement of the foam patch is dependent on the window and the amount of water evacuation.

### II. With Reference to the Figures

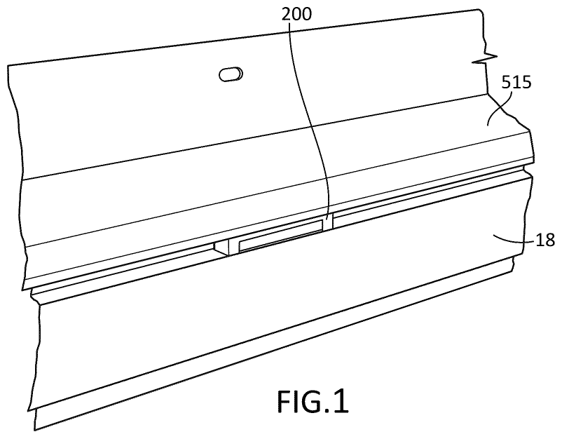

Referring now to the figures, FIG. 1 depicting an example of a head 18 of a window is shown. The head 18 has a drainage system (e.g., a wicking structure 200 (discussed in more detail in reference to FIG. 2) and a water channel cover 515 (discussed in more detail in reference to FIG. 6 below)). The wicking structure and designs discussed herein may be used with various types of window frames and windows. As such, an example window may have a window frame that includes a head and a sill and a left jamb and a right jamb. Inside the window frame, there is a window pane and the outside of window frame carries a nail fin that is to be nailed to the outside of the framing around window.

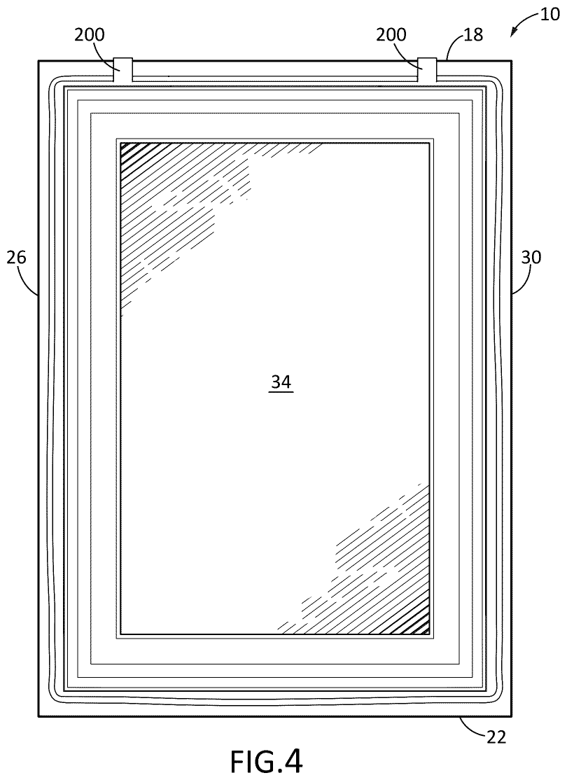

An example, window frame 10 is shown in FIG. 4 with potential placement locations of the wicking structures 200 shown. FIG. 2, discussed below, illustrates the head 18 of FIG. 1 without the water channel cover 515 (e.g., allowing visual access to the placement and structure of the wicking structure 200). In various embodiments, wicking structures may be used with or without the water channel cover 515.

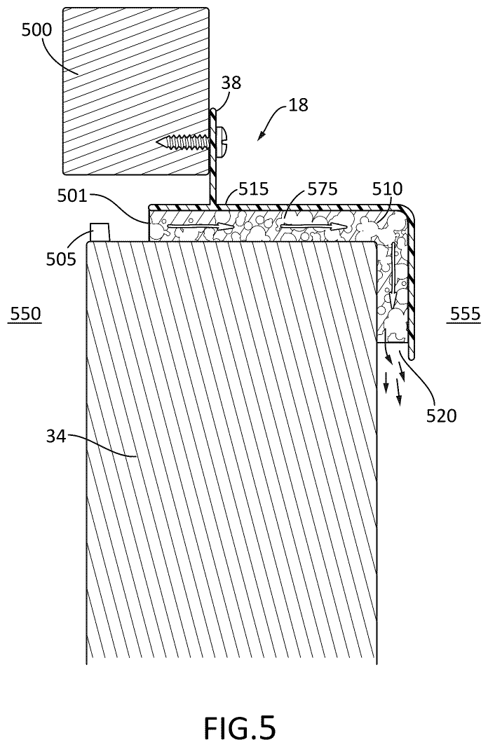

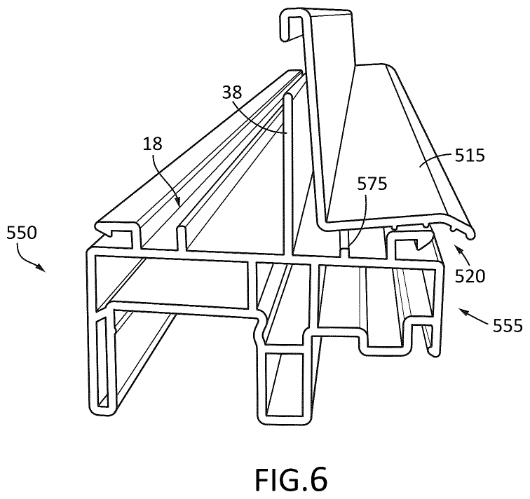

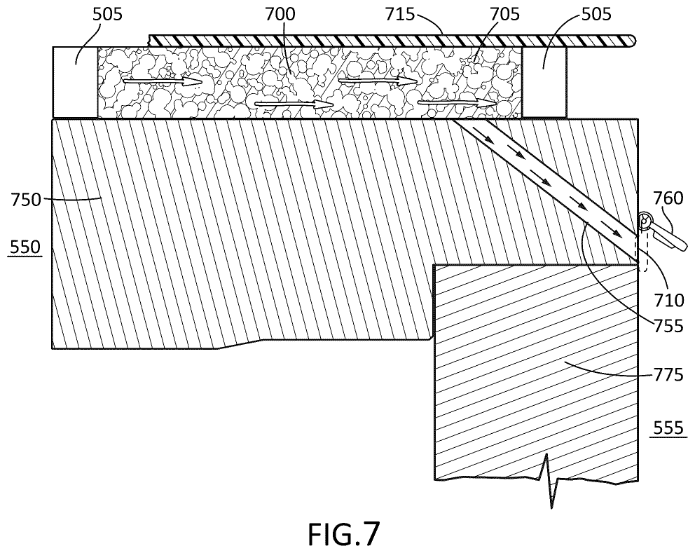

FIG. 2 depicts an illustration of a lineal with a top nailing surface and a wicking structure 200 along the head 18. The wicking structure 200 includes a foam patch located to weep or evacuate water that enters the head of a window framing. As discussed herein, the wicking structure 200 may include any of the structure shown in FIG. 5 or 7. Additionally, FIG. 4 illustrates example placement locations for the wicking structure 200. However, any number of different mounting positions may be contemplated, as discussed herein.

The wicking structure 200 of FIG. 2 illustrates a clipping cover 215 that engage with the structure of the head 18. For example, the head 18 may define rail(s) 220, 225 that the clipping cover 215 engages. The clipping cover 215 may include one or more indentions (e.g., indentions 230, 235). The indentions of the clipping cover 215 and the head 18 upon placement of the clipping cover 215 may define apertures for water or other liquids to enter and/or exit the clipping cover 215. As shown, the liquid may enter/exit the clipping cover 215 via the inlet aperture 240, an inlet aperture 250 defined on the clipping cover 215 opposite the inlet aperture 240 along the length of the head 18, and/or exit aperture 245. In an example embodiment, as shown in FIG. 5, the exit aperture 245 may correspond to the water channel outlet 520, and the inlet aperture 240 and/or the inlet aperture 250 may correspond to the water channel opening 501 (e.g., the water channel opening 501 may include multiple openings). As shown in FIG. 7, the exit aperture 245 of FIG. 2, may be replaced with a water channel aperture 755 defined in the window frame (e.g., a directing structure 505 may prevent the liquid from moving through the exit aperture 245).

Continuing with FIG. 2, the wicking structure 200 includes an absorption layer 275. The absorption layer 275 may correspond to the absorption layer 56 of FIG. 3, the absorption layer 510 of FIG. 5 and/or the absorption layer 705 of FIG. 7. As such, the material, characteristics, and/or placement may be the same or similar across FIGS. 2, 3, 5, and/or 7. The absorption layer 275 may be a foam patch or layer that includes wicking characteristics to absorb at least a portion of the water passing therethrough.

The absorption layer may be defined using one or more foam materials. The foam of the absorption layer may be an open-cell foam with a first protective cover adhered to one face and a second protective cover adhered to the opposing face. Protective cover may be peeled from an adhesive layer; second protective cover may be peeled from an adhesive layer. Example foam patches used as an absorption layer may be 5 centimeters (2 inches) high, 2.5 centimeters (1 inch) wide, and 2-3 millimeters thick. The precise dimensions will depend on the application and a modest amount of experimentation well within the capability of a window manufacturer.

FIG. 6 illustrates the head 18 of FIG. 2 with the water channel cover 515 (or drip cap) attached. The water channel cover 515 is removed in FIG. 2 to illustrate the interior of the lineal structure (e.g., placement of the wicking structure 200). The water channel cover 515 may be attached to the window head 18 via the attachment means 205. The attachment means 205 may be removable (e.g., a hook and loop fastener) or non-removable (e.g., an adhesive, bolt/screw fastener, and/or the like). While the attachment means 205 is shown as a spot along the nailing fin 38, any number of different attachment means may be used.

Referring now to the FIG. 3, an example absorption layer 56 is shown. The absorption layer 56 may be used for any of the absorption layer and/or foam patches discussed herein (e.g., absorption layer 275 of FIG. 2, absorption layer 510 of FIG. 5, and/or absorption layer 705 of FIG. 7). The absorption layer 56 is merely shown as an example. The absorption layer may be any type of material that provides the effects discussed herein (e.g., wicking of the moisture within the water channel). While the absorption layer 56 is referred to as a layer, the absorption layer 56 may include any number of layers and/or sub-layers.

The absorption layer 56 is a foam material 70 (e.g., open-cell foam) with a first protective cover 72 adhered to one face and a second protective cover 74 adhered to the opposing face. The first protective cover 72 may be peeled from a first adhesive sub-layer 76 and the second protective cover 74 may be peeled from a second adhesive sub-layer 78 (as shown in FIG. 3). The first protective cover 72 and/or the second protective cover 74 may be removed from the absorption layer 56 to allow for the absorption layer 56 to be attached to the drainage system (e.g., attached to the wicking structure 200, the head 18, and/or the water channel cover 515). In various embodiments, the absorption layer 56 may be attached to the drainage system via the first adhesive sub-layer 76 (upon removing the first protective cover 72) and/or the second adhesive sub-layer 78 (upon removing the second protective cover 74).

In various embodiments, the absorption layer 56 may be approximately 5 centimeters (2 inches) high, 2.50 centimeters (1 inch) wide, and 2-3 millimeters thick. The height, width, and/or thickness may be based on the foam material only (e.g., the foam of FIG. 3 between the first adhesive sub-layer 76 and the second adhesive sub-layer 78). The precise dimensions may depend various factors, such as type of environment (e.g., more moisture may require a larger absorption layer), frame design (e.g., the type of frame may affect the sizing of the material that would fit within the water channel), the number of wicking structures (e.g., more wicking structures on a frame may require smaller individually absorption layers), and/or the like.

The size of the absorption layer 56 (e.g., the height, width, and/or thickness of the foam 70) may be independently adjusted. Generally speaking, the higher the volume of the absorption layer 56, the more wicking ability, assuming the same material being used. Any number of different wicking materials may be used as the foam 70 within the absorption layer 56. Water that drains via the drainage system, upon reaching the absorption layer 56, is wicked into the foam and then drains naturally via a water channel outlet by a combination of gravity, wicking, surface tension and pressure from the water within the water channel.

Referring now to FIG. 4, an example wicking structure is provided for the top of the window or door assembly. As shown in FIG. 4, the top of the head 18 of the window 10 may have one or more wicking structures 200 (as shown in FIG. 2). The wicking structures 200 shown in FIG. 4 are illustrated to show potential placement locations along the head 18 of the window 10. For example, the wicking structures 200 may be spaced from one another to interface with liquid in the window frame.

While the wicking structures 200 are shown as two wicking structures, any number of wicking structures may be contemplated on head 18. For example, a single wicking structure may be provided (e.g., in the center of the head 18 and/or at another location). Alternatively, more than two wicking structures may be provided.

In various embodiments, in an instance in which two wicking structures are provided, as shown in FIG. 4, the wicking structures may each be positioned approximately evenly opposing jambs. For example, a first wicking structure of the wicking structures 200 may be a predetermined distance (e.g., approximately 7 centimeters to 8 centimeters) from the left jamb 26 and a second wicking structure of the wicking structures 200 may be the same predetermined distance (e.g., approximately 7 centimeters to 8 centimeters) from the right jamb 30. The distance may be adjusted based on the size of the window and/or the size of the wicking structure 200.

In various embodiments, the wicking structure 200 may extend along at least a portion of the head 18. For example, a wicking structure 200 may extend the length of the head 18 (between the left jamb 26 and the right jamb 30). The number of wicking structures and/or the length of the wicking structure 200 (and subsequently the absorption layer within the wicking structure) along the head 18 may be based on the expected amount of liquid in and/or near the window frame. For example, a rainy or more humid area may require more wicking structures and/or longer wicking structures to remove liquid in and/or near the window frame. Alternatively, dryer areas may only require a single wicking structure.

The wicking structure(s) 200 may be attached to the window frame (e.g., as shown in FIGS. 2 and 5) and/or be part of the window frame (e.g., apertures may be drilled into the window frame as shown in FIG. 7). While two wicking structure(s) 200 are shown, any number of wicking structures may be provided (e.g., one wicking structure, two wicking structures, three wicking structures, etc.). In various embodiments, the number of wicking structures 200 provided on a head 18 may be based on the size of the window (e.g., the longer the head 18 of the window, the more wicking structures that may be provided).

In various embodiments, the wicking structure(s) 200 may be positioned at any number of different locations along the head. Additional wicking structures(s) 200 may also be provided around the frame (e.g., on the right jamb 26, the left jamb 30, and/or the sill 22).

Referring now to FIG. 5, another example embodiment of a drainage system for a window is shown. Upon installation, the window defines an interior side 550 (e.g., facing an interior of a building) and an exterior side 555. The head 18 abuts the wall frame 500, such that the nailing fin 38 is adjacent to the wall frame 500. However, water may seep between the head 18 and the wall frame.

The drainage system of FIG. 5 uses the head 18 of the window frame as the water channel cover 515. The water channel cover 515 defined by the head 18 creates a water channel 575 between the head 18 and the pane 34. The water channel 575 has a water channel opening 501. The water channel opening 501 may be one or more openings to receive the water. The water channel opening 501 may correspond to the inlet aperture 240, 250 shown in FIG. 2 on the wicking structure. The water channel opening 501 is provided to receive any water that seeps into the area between the wall frame 500 and the head 18.

A directing structure 505 provides a damming effect that blocks the water from exiting to the interior side 550 of the window. The directing structure 505 directs the water into the water channel 575. The directing structure may extend along the head 18 of the window (e.g., along the first axis defined between the left jamb 26 and the right jamb 30). The directing structure may be part of the window frame (e.g., unitary to the head 18), part of the pane 34, and/or otherwise attached to the pane 34.

The water channel 575 may extend along the first axis defined between the left jamb 26 and the right jamb 30 (e.g., from the wicking structures in the direction of the left jamb 26 and/or right jamb 30 shown in FIG. 2). In various embodiments, the water channel 575 may be slanted along the first axis (e.g., in the direction of the water channel outlet 520). Additionally, the water channel 575, as shown in FIG. 5, may extend along a second axis defined between the interior side 550 and the exterior side 555 of the window. As such, the water channel 575 extends along the head 18 of the window and then across the head 18 from the interior side 550 to the exterior side 555 of the window. The water channel 575 may define a water channel outlet 520 that allows the water to leave the window frame. As such, the water is removed to the exterior of the window, reducing the amount of water pooling within the window frame and adjacent areas without causing unnecessary water from entering the interior of a structure. Various embodiments may include any number of water channel opening(s) 501 and/or water channel outlet(s) 520.

The water channel 575 may have an absorption layer 510 defined within the water channel. In such an embodiment, the absorption layer 510 absorbs the water that enters into the water channel 575. The absorption layer 510 may be defined using an absorption material, such as foam. For example, the absorption layer 510 may include a foam tape layer. In various embodiments, the absorption layer 510 may include a semi-permeable foam tape. In various embodiments, the absorption layer may include one or more materials used for the foam patches discussed in reference to FIG. 3.

The absorption layer 510 may be provided along the entire water channel 575, as shown in FIG. 5. Alternatively, the absorption layer 510 may be defined in a portion of the water channel (e.g., a piece of a foam may be positioned at a location within the water channel 575). In various embodiments, the absorption layer 510 may be any number of materials (e.g., any number of layers, combinations, and/or the like). The absorption layer 510 may include material to absorb and/or otherwise slow the flow of the water within the water channel 575. As such, the flowrate of the water exiting via the water channel outlet 520 is reduced (e.g., to prevent large amounts of water being routed to the exterior side of the window).

The water channel 575 may also define a water channel cover 515 which prevents the water within the water channel 575 from entering an unintended portion of the window frame and/or adjacent area. The water channel cover 515 may be part of the head 18 (as shown in FIG. 5) and/or be provided as an attachment to the head 18 (as shown in FIG. 6). The water channel cover 515 may assist in directing the water flowing through the water channel 575. In various embodiments, the water channel 575 may have a slanting in the direction of the exterior side 555, such that the water flows in the direction of the water channel outlet 520. The water channel outlet 520 may correspond to the exit aperture 245 shown in FIG. 2.

Referring now to FIG. 6, a slightly different embodiment of the drainage system is shown. The example shown in FIG. 6 correspond to the example shown in FIG. 2 with the addition of the water channel cover 515. The structure of FIG. 6 may be used on a window frame, such as the window frame of FIG. 4. As such, the water channel cover 515 is attached to the head 18 forming the water channel between the water channel cover 515 and the head 18. One or more wicking structures 200 (shown in FIG. 2) may be provided along the head 18 under the water channel cover 515. The wicking structure(s) 200 may be used to reduce the flow rate of the liquid being moved out of the window frame, as discussed herein.

As shown in FIG. 6, the water channel 575 may be defined between the nailing fin 38 and the exterior side 555 of the head. The water channel 575 is similarly defined along the first axis defined along the head 18 between the left jamb 26 and the right jamb 30. The water channel cover 515 is defined along the water channel 575 as an attachment to the head 18. In various embodiments, the water channel cover 515 may allow water to pass between the water channel cover 515 and the head, such that water travels out in the direction of the exterior side 555 of the head (e.g., out of the water channel outlet 520).

In the embodiment shown, the nailing fin 38 may act as a directing structure to direct the water in the direction of the water channel outlet 520. Additional directing structures may be provided to direct the water within the water channel to the wicking structures. For example, a portion of the water channel outlet 520 may be blocked (e.g., via sealing or other methods) to direct the water within the water channel into the wicking structure(s) 200. As such, the only exit for the water within the water channel 575 may be via an exit aperture 245 of the wicking structure(s) 200.

Referring now to FIG. 7, another example wicking structure is used for a door 775. While the various embodiments are shown using doors or windows, unless otherwise noted any of the embodiments discussed herein may be used in either a window or a door. For example, the wicking structure of FIG. 7 may be used for a window structure and the wicking structure of FIGS. 5 and 6 may be used for a door structure.

As shown, a water channel 700 is provided above the head 750 of a door frame (e.g., on the side opposite the door 775). As such, the water channel 700 receives water that would otherwise sit on the head 750 of the door frame and potentially cause damage. The water channel 700 may include an absorption layer 705. The absorption layer 705 may include the same or similar material to the absorption layer discussed in reference to FIG. 5. A water channel cover 715 may be provided to define the water channel 700. In various embodiments, the water channel cover may be the wall above which the door frame is installed. As such, the water travels between the head 750 and the water channel cover 715. In various embodiments, the absorption layer 705 may be defined at least partially between the head 750 and the water channel cover 715. In various embodiments, the portion of the water channel 700 before reaching the water channel aperture 755 may be slanted in the direction of the water channel aperture 755 (e.g., to allow gravity to assist the movement of the water along the water channel 700 in the direction of the water channel outlet 710).

A water channel aperture 755 may be defined within the head 750. The water channel aperture 755 may be drilled into the head 750 (e.g., predrilled, such that the water channel aperture 755 is defined before being installed). The water channel aperture may be slanted such that the water travels in the direction of the ground (e.g., allowing gravity to carry the water along the water channel aperture in the direction of the water channel outlet 710). An absorption layer (either separate or the same as the absorption layer defined above the head 750) may also be defined within at least a portion of the water channel aperture 755.

The water channel outlet 710 may have a cover 760 that prevents water or other materials from unnecessarily entering the water channel outlet 710. As such, the cover 760 may act as a deflector that directs the water from the water channel 700 in the direction of the ground and prevents water from entering the water channel outlet 710. The cover 760 may be fixed (e.g., directing the water to the ground or the cover 760 may be hinged, to allow the cover 760 to swing between an open and closed position, as shown in FIG. 7). In an example in which the cover 760 is hinged, the cover 760 may cover the water channel outlet 710 in the closed position and the force of the water within the water channel against the cover 760 may cause the cover 760 to move into the open position (e.g., allowing the water within the water channel to exit via the water channel outlet 710).

In various embodiments, one or more directing structures 505 may be provided to direct the water within the water channel 700. As shown, a directing structure is provided to prevent water from entering the interior side 550 of the head 750. A water channel opening may be defined between the directing structure 505 defined adjacent the interior side 550. Another directing structure 505 may be provided to direct the water into the water channel aperture 755 (e.g., preventing the water from diverting into the wall adjacent to the frame). For example, the directing structure 505 may be defined closer to the exterior side 555 than inlet to the water channel aperture, such that the water may either enter the water channel aperture 755 freely or bounce off of the directing structure 505 into the water channel aperture 755.

Those familiar with window manufacturing and installation will appreciate that changes and substitutions may be made in the foregoing description of the improved window without departing from the spirit and scope of the disclosure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### III. Claim Clauses

Clause 1. A drainage system for a window or a door, the drainage system comprising: a frame comprising a head; a water channel adjacent to the head defined between a water channel opening and a water channel outlet, wherein water travels along the water channel; and a first wicking structure positioned within the water channel, wherein the first wicking structure comprises an absorption layer, wherein the water traveling along the water channel exits on an exterior side of the frame.

Clause 2. The drainage system of Clause 1, further comprising a water channel cover, wherein the water channel is defined between the water channel cover and the head.

Clause 3. The drainage system of Clause 1, wherein the water channel is defined between the head and a pane of the frame.

Clause 4. The drainage system of Clause 1, wherein a portion of the water channel includes a water channel aperture defined within the frame.

Clause 5. The drainage system of Clause 1, further comprising a directing structure positioned adjacent to an interior side of the frame, wherein water is prevented from exiting the interior side of the frame via the directing structure.

Clause 6. The drainage system of Clause 1, wherein the water channel is slanted along the water channel in a direction of the water channel outlet.

Clause 7. The drainage system of Clause 1, wherein the first wicking structure defines an inlet aperture and an outlet aperture, wherein the inlet aperture and the outlet aperture are defined between a clipping cover of the first wicking structure and the head of the frame.

Clause 8. The drainage system of Clause 7, wherein the outlet aperture of the first wicking structure is the water channel outlet.

Clause 9. The drainage system of Clause 1, wherein the absorption layer comprises a foam tape.

Clause 10. The drainage system of Clause 1, wherein the absorption layer is an open-cell foam.

Clause 11. The drainage system of Clause 1, further comprising a water channel cover that directs the water exiting the water channel outlet.

Clause 12. The drainage system of Clause 1, further comprising at least one additional wicking structure, wherein each of the first wicking structure and the at least one additional wicking structure is defined along the head.

Clause 13. The drainage system of Clause 1, wherein the frame is for a window.

Clause 14. The drainage system of Clause 1, wherein the frame is for a door.

Clause 15. The drainage system of Clause 1, wherein the water channel directs the water from an interior side to the exterior side of the frame.

Clause 16. A method of manufacturing a drainage system for a window or a door, the method comprising: providing a frame comprising a head; defining a water channel adjacent to the head between a water channel opening and a water channel outlet, wherein water travels along the water channel; and positioning a first wicking structure on the head within the water channel, wherein the first wicking structure comprises an absorption layer, wherein the water traveling along the water channel exits on an exterior side of the frame.

Clause 17. The method of Clause 16, further comprising attaching a water channel cover to the head, wherein the water channel is defined between the water channel cover and the head.

Clause 18. The method of Clause 16, wherein the water channel is defined between the head and a pane of the frame.

Clause 19. The method of Clause 16, wherein a portion of the water channel includes a water channel aperture defined within the frame.

Clause 20. The method of Clause 16, further comprising defining a directing structure adjacent to an interior side of the frame, wherein water is prevented from exiting the interior side of the frame via the directing structure.

Clause 21. The method of Clause 16, wherein the water channel is slanted along the water channel in a direction of the water channel outlet.

Clause 22. The method of Clause 16, wherein the first wicking structure defines an inlet aperture and an outlet aperture, wherein the inlet aperture and the outlet aperture are defined between a clipping cover of the first wicking structure and the head of the frame.

Clause 23. The method of Clause 22, wherein the outlet aperture of the first wicking structure is the water channel outlet.

Clause 24. The method of Clause 16, wherein the absorption layer comprises a foam tape.

Clause 25. The method of Clause 16, wherein the absorption layer is an open-cell foam.

Clause 26. The method of Clause 16, further comprising providing a water channel cover that directs the water exiting the water channel outlet.

Clause 27. The method of Clause 16, further comprising positioning at least one additional wicking structure, wherein each of the first wicking structure and the at least one additional wicking structure is defined along the head.

Clause 28. The method of Clause 16, wherein the frame is for a window.

Clause 29. The method of Clause 16, wherein the frame is for a door.

Clause 30. The method of Clause 16, wherein the water channel directs the water from an interior side to the exterior side of the frame.

Therefore, the following is claimed:

1. A drainage system for a window or a door, the drainage system comprising:
a frame comprising a head;
a water channel adjacent to the head defined between a water channel opening and a water channel outlet, wherein water travels along the water channel; and
a first wicking structure positioned within the water channel, wherein the first wicking structure comprises an absorption layer,
wherein the water traveling along the water channel exits on an exterior side of the frame.

2. The drainage system of claim 1, further comprising a water channel cover, wherein the water channel is defined between the water channel cover and the head.

3. The drainage system of claim 1, wherein a portion of the water channel includes a water channel aperture defined within the frame.

4. The drainage system of claim 1, further comprising a directing structure positioned adjacent to an interior side of the frame, wherein water is prevented from exiting the interior side of the frame via the directing structure.

5. The drainage system of claim 1, wherein the water channel is slanted along the water channel in a direction of the water channel outlet.

6. The drainage system of claim 1, wherein the first wicking structure defines an inlet aperture and an outlet aperture, wherein the inlet aperture and the outlet aperture are defined between a clipping cover of the first wicking structure and the head of the frame.

7. The drainage system of claim 6, wherein the outlet aperture of the first wicking structure is the water channel outlet.

8. The drainage system of claim 1, wherein the absorption layer is an open-cell foam.

9. The drainage system of claim 1, further comprising a water channel cover that directs the water exiting the water channel outlet.

10. The drainage system of claim 1, further comprising at least one additional wicking structure, wherein each of the first wicking structure and the at least one additional wicking structure is defined along the head.

11. A method of manufacturing a drainage system for a window or a door, the method comprising:
providing a frame comprising a head;
defining a water channel adjacent to the head between a water channel opening and a water channel outlet, wherein water travels along the water channel; and
positioning a first wicking structure on the head within the water channel, wherein the first wicking structure comprises an absorption layer,
wherein the water traveling along the water channel exits on an exterior side of the frame.

12. The method of claim 11, further comprising attaching a water channel cover to the head, wherein the water channel is defined between the water channel cover and the head.

13. The method of claim 11, wherein a portion of the water channel includes a water channel aperture defined within the frame.

14. The method of claim 11, further comprising defining a directing structure adjacent to an interior side of the frame, wherein water is prevented from exiting the interior side of the frame via the directing structure.

15. The method of claim 11, wherein the water channel is slanted along the water channel in a direction of the water channel outlet.

16. The method of claim 11, wherein the first wicking structure defines an inlet aperture and an outlet aperture, wherein the inlet aperture and the outlet aperture are defined between a clipping cover of the first wicking structure and the head of the frame.

17. The method of claim 16, wherein the outlet aperture of the first wicking structure is the water channel outlet.

18. The method of claim 11, wherein the absorption layer is an open-cell foam.

19. The method of claim 11, further comprising providing a water channel cover that directs the water exiting the water channel outlet.

20. The method of claim 11, further comprising positioning at least one additional wicking structure, wherein each of the first wicking structure and the at least one additional wicking structure is defined along the head.
